(19) United States
(12) Patent Application Publication
(10) Pub. No.: US 2008/0123831 A1
(43) Pub. Date: May 29, 2008

(54) SYSTEMS AND METHODS FOR CALL ROUTING

(76) Inventors: Mads Flensted-Jensen, Virum (DK); Arne Winther, Virum (DK)

Correspondence Address: CHOATE, HALL & STEWART LLP, TWO INTERNATIONAL PLACE, BOSTON, MA, 02110, US

(21) Appl. No.: 11/563,141

(22) Filed: Nov. 24, 2006

(51) Int. Cl. H04M 3/42

(52) U.S. Cl. 379/212.01

(57) ABSTRACT

Systems and methods for call routing are shown and described. The method can include receiving, at a site external to a mobile telephone network, an incoming telephone call via a first fixed line telephone number, signaling a mobile telephone network to initiate a call to the site external to the mobile telephone network, receiving a second incoming call from a mobile telephone of the mobile telephone network via a second fixed line telephone number, and connecting the first incoming telephone call to the second incoming telephone call to establish a connected call.

### FIELD OF THE INVENTION

This application relates generally to providing telephony services. More specifically, the application relates to systems and methods for call routing.

### BACKGROUND OF THE INVENTION

Traditionally, telephony operators provide telephony services by placing components within their networks. Some functionality can be owned by a subscriber of a fixed line network (e.g., Integrated Services Digital Network, Plain Old Telephone System, or another packet switched network). For example, a business can purchase a private branch exchange (PBX). The PBX interfaces with the fixed line network and also to each of the dedicated fixed lines within the business.

Some companies do not have the resources to purchase their own PBX equipment. As such, a PBX hosting service charges a fee for interfacing the companies fixed lines to a PBX that is owned by the hosting service. One example of a company providing such services is VIRTUAL PBX of San Jose, Calif.

To provide a mobile phone an extension using a traditional PBX, “tromboning” of a call through the PBX is required. Tromboning refers to transferring a call to a mobile phone via a PBX where the resulting call occupies one inbound phone line and one outbound phone line for the duration of the call. Tromboning adds extra cost for the enterprises using it.

### SUMMARY OF THE INVENTION

In one aspect, the application features a method of providing telephony services as a hosted online service for a subscription fee.

In another aspect, the application features systems and methods for hosting telephony services.

In still another aspect, the application features systems and methods for routing a call within an enterprise.

In one aspect, the invention features a method of routing a call received at a fixed line number to an enterprise extension. The method includes receiving, at a site external to a mobile telephone network, an incoming telephone call via a first fixed line telephone number, signaling a mobile telephone network to initiate a call to the site external to the mobile telephone network, receiving a second incoming call from a mobile telephone of the mobile telephone network via a second fixed line telephone number, and connecting the first incoming telephone call to the second incoming telephone call to establish a connected call.

In one embodiment, the first fixed line number and the second fixed line number are the same. In one embodiment, the methods also includes issuing a transfer command to the mobile telephone network to transfer the connected call to another mobile telephone. In another embodiment, the method includes issuing a transfer command to the mobile telephone to transfer the connected call to another mobile telephone.

In one embodiment, the signaling a mobile telephone network includes signaling a mobile telephone network to initiate a call to the mobile telephone and the site external to the mobile network. In another embodiment, the method includes signaling an intermediate component of the mobile telephone network to initiate a call to the mobile phone and the site external to the mobile network to establish the connected call. In a further embodiment, the method includes signaling a second mobile telephone of the mobile telephone network

Further features and advantages of the present invention will be apparent from the following description of preferred embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 depicts an embodiment of an environment for hosting telephony services;

FIG. 2 depicts a block diagram of an embodiment of a mobile telephone network;

FIG. 3 depicts another embodiment of an environment for hosting telephony services;

FIG. 4 depicts a conceptual block diagram of an embodiment of a mobile communications device;

FIG. 5 depicts a conceptual block diagram of an embodiment of a computing device;

FIG. 6 depicts a conceptual block diagram of an embodiment of a data center;

FIG. 7 depicts a conceptual screen shot of an embodiment of a graphical user interface for providing telephony services;

FIG. 8 depicts a flow chart of an embodiment of a method of providing telephony services to an enterprise; and

FIG. 9 depicts a flow chart of an embodiment of a method of routing a call within an enterprise.

### DETAILED DESCRIPTION

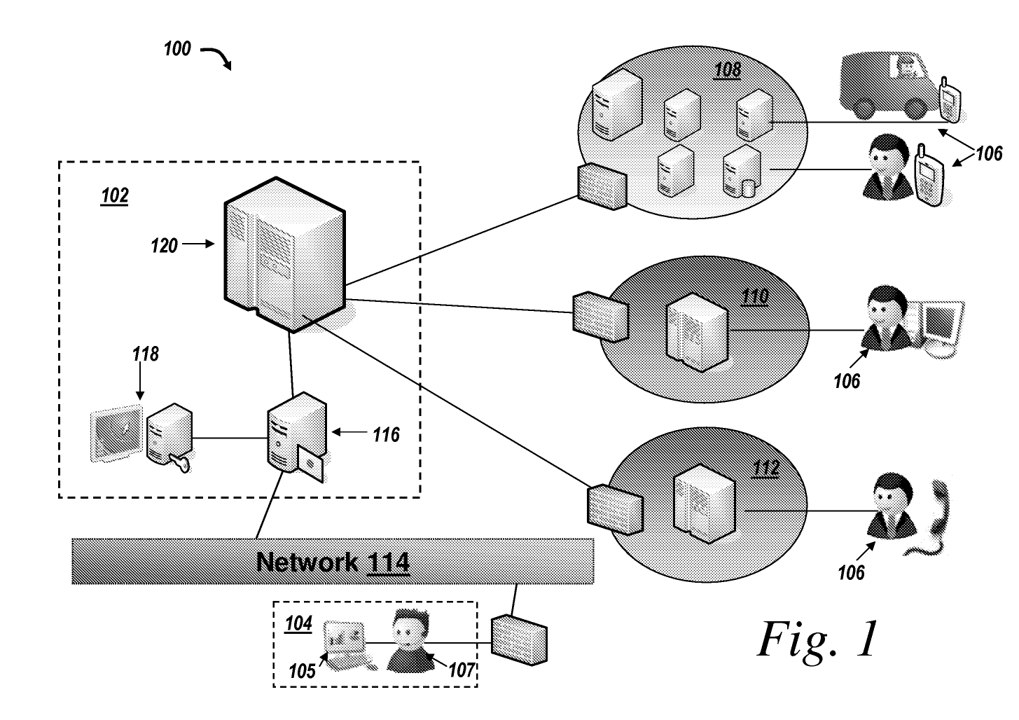

With reference to FIG. 1, one embodiment of an environment 100 for providing hosted telephony services to an enterprise is shown and described. As used herein enterprise refers to an organization created for a business venture. The environment 100 includes a data center 102, an enterprise operator 104, and one or more subscribers 106 to one or more of: a mobile network 108, a packet switched network 110, and a circuit switched network 112. The enterprise operator 104 is in communication with the data center 102 via a network 114. The data center 102 is also in communication with one or more of the mobile network 108, the packet switched network 110, and the circuit switched network 112.

The enterprise operator 104 can have a computing device 105 executing software that provides at least some of the below-described functionality. A human operator 107 interacts with the computing device 105 to, for example, issue commands from the computing device 105 to the data center 102, which in turn issues commands to the mobile network 108, to transfer an incoming fixed line call to a mobile telephone associated with the enterprise subscribing for telephony services. As used herein, telephony services include, but are not limited to, auto attendant (IVR), switchboard, hunting groups, ring groups, personal assistant, short number dialing, PBX services, barring, ACD, conferencing, and others.

The network 114 that connects the enterprise operator 104 with the data center 102 can be a local-area network (LAN), a metropolitan-area network (MAN), or a wide area network (WAN) such as the Internet or the World Wide Web. The enterprise operator 104 connects to the network 140 via communications link using any one of a variety of connections including, but not limited to, standard telephone lines, LAN or WAN links (e.g., T1, T3, 56 kb, X.25), broadband connections (ISDN, Frame Relay, ATM), and wireless connections. The connections can be established using a variety of communication protocols (e.g., TCP/IP, IPX, SPX, NetBIOS, and direct asynchronous connections).

In other embodiments, the enterprise operator 104 connects to the data center 102 through a second network (not shown) using another communication link that connects network 114 to the second network. The protocols used to communicate through the communications link can include any variety of protocols used for long haul or short transmission. For example, TCP/IP, IPX, SPX, NetBIOS, NetBEUI, SONET and SDH protocols or any type and form of transport control protocol may also be used, such as a modified transport control protocol, for example a Transaction TCP (T/TCP), TCP with selection acknowledgements (TCPSACK), TCP with large windows (TCP-LW), a congestion prediction protocol such as the TCP-Vegas protocol, and a TCP spoofing protocol. In other embodiments, any type and form of user datagram protocol (UDP), such as UDP over IP, may be used. The combination of the networks can be conceptually thought of as the Internet. As used herein, Internet refers to the electronic communications network that connects computer networks and organizational computer facilities around the world.

The packet switched network 110 communicates with the data center 102. As used herein a packet switched network refers to a data communications network where information (e.g., voice and data) is divided into packets and delivered to their destination separately and possibly via different paths. Some packet switched networks provide voice-over-IP (VoIP) functionality. The data center 102 can provide telephone services to enterprise subscribers having telephone devices terminated on the packet switched network 110. As used herein, telephone devices refers telephones, fax machines, computers, IP phones, soft phones, video phones, mobile phones, wlan phones, or other devices capable of transmitting and receiving audible information.

The circuit switched network 112 also communicates with the data center 102. As used herein circuit switched refers to routing traffic between an originator and a destination through switching centers, from local users or from other switching centers, whereby a continuous electrical circuit is established and maintained between the calling and called stations until it is released by one of those stations. For example, the switched circuit network 112 can be the public switched telephone network (PSTN). The data center 102 can provide telephone services to enterprise subscribers having telephone devices terminated on the circuit switched network 112.

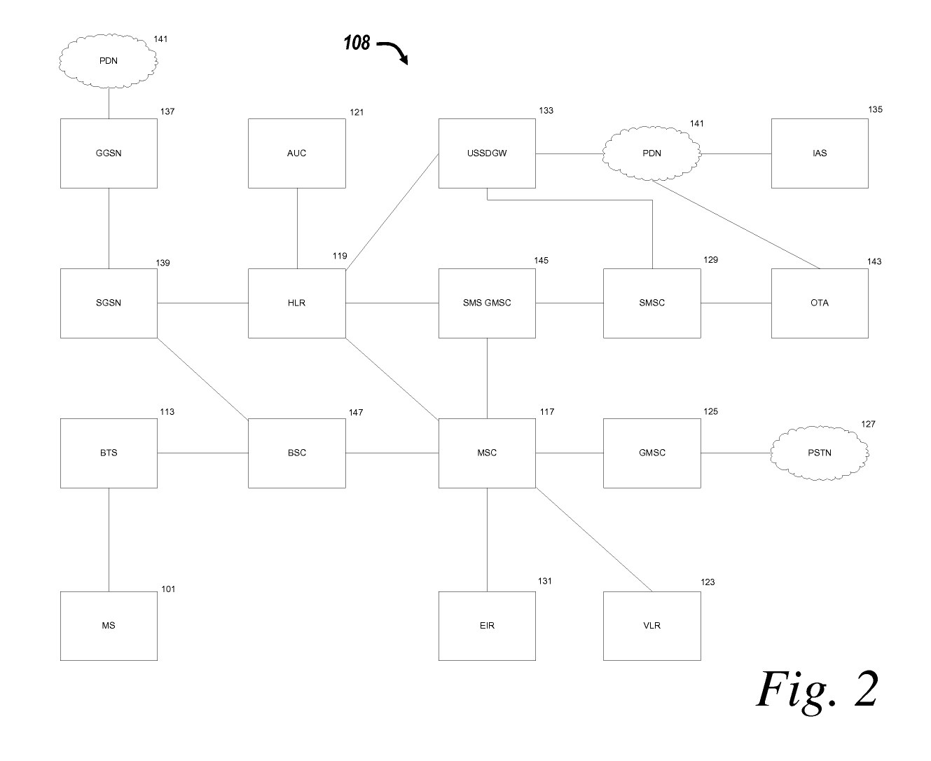

The mobile network 108 communicates with the data center 102. As used herein, mobile network refers to facilities operated by a telephony carrier for the purposes of providing public mobile telecommunications services. Various embodiments, of the mobile network 108 are described in more detail below with reference to FIG. 2. The data center 102 can provide telephone services to enterprise subscribers having telephone devices terminated on the mobile switched network 108.

The data center 102, in one embodiment, includes, a web server 116, a control device 118, and a network operation center (NOC) 120. Although shown as separate components, the web server 116, the control device 118, and the NOC 120 can be combined in many ways and supported by a one or more computing devices. The data center 102 is located external to at least one of the mobile network 108, the packet switched network 110, and the circuit switched network 112. That is, the data center 102 is not under control of an operator of either of the mobile network 108, the packet switched network 110, and the circuit switched network 112. The data center 102 provides an ingress point to one or more of the mobile network 108, the packet switched network 110, and the circuit switched network 112. Also, the data center 103 can serve as a termination point for a fixed line telephone number associated with an enterprise subscribing with the operator of the data center 102 for telephony services. A single data center 102 can support one or more subscribing enterprises. In some embodiments, multiple data centers 102 are present.

As an operational summary, the data center 102 interfaces to one or more of the mobile network 108, the packet switched network 110, and the circuit switched network 112 to provide fixed line call pricing to customers of the enterprise even though the enterprise uses mobile phones. The data center 102 can provide telephone services to enterprise subscribers having telephone devices terminated on a packet switched network or a mobile network 108. In one embodiment, an enterprise subscriber contracts for telephone services. In turn, a fixed line telephone number associated with enterprise subscriber is terminated at the data center 102.

This fixed line main number can be the initial entry point for an enterprise. In some instances, the fixed line main number is well known by customers and potential customers of the enterprise. For example, 1-800-FLOWERS is a well known fixed line main number. In some regions of the world, it is less expensive to call a fixed line number than a mobile telephone number. It may also be less expensive for the enterprise to receive calls at a fixed line number instead of mobile telephone numbers associated with respective principals of the enterprise. Continuing with the 1-800-FLOWERS example, if that enterprise decided to replace their existing PBX services with telephony services described herein the enterprise would likely want to keep their 1-800-FLOWERS fixed line number. By porting the known fixed line number to the data center 102, the enterprise can provide PBX and other telephony services to mobile telephones associated with the enterprise without relinquishing their known fixed line numbers. Another benefit is that customers calling 1-800-FLOWERS are not be charged at a fixed-line-to-mobile rate, instead they are charged at fixed lined-to-fixed-line rate. Further details of these benefits are described below in more detail.

Referring now to FIG. 2, an embodiment of a mobile network 108 is shown. A mobile network 108 may comprise one or more, and any or all of the following: wireless devices described in the art as Mobile Stations (MS) 101; Base transceiver stations (BTS) 113, Base station controllers (BSC) 147, Mobile switching centers (MSC) 117, Home location registers (HLR) 119, Authentication centers (AuC) 121, Visitor location registers (VLR) 123, Gateway mobile switching centers (GMSC) 125, Public Switched Telecomm Networks (PSTN) 127, Short Message Service centers (SMSC) 129, Equipment Identity Registers (EIR) 131, Unstructured Supplementary Services Data (USSDGW) gateways 133, Internet Application Servers (IAS) 135, Gateway General Packet Radio Service (GPRS) Support Nodes (GGSN) 137, Serving GPRS Support Nodes (SGSN) 139, Packet Data Networks (PDN) 141, SIM OTA Servers (OTA) 143, and SMS Gateway MSCs (SMS GMSC) 145. The components of a network 105 may be connected in any topology using any interconnect technology.

The mobile network 108 described herein can include a generalized GSM/GPRS network, though a person skilled in the art would appreciate that the invention may be deployed in alternative networks employing different bearers, protocols, technologies, architectures and topologies. In other embodiments, a network 108 may employ one or more of: Universal Mobile Telecommunications Service (UMTS), Code Division Multiple Access (CDMA including CDMA2000 1x, CDMA2000 1xEV-DO, CDMA2000 1xEV-DV, CDMA TIA/EIA/ANSI-95A/B), GPRS, Enhanced Data rates for GSM Evolution (EDGE), Wideband Code Division Multiple Access (W-CDMA), Personal Digital Cellular (PDC), Integrated Digital Enhanced Network (iDEN), High-Speed Uplink Packet Access (HSUPA) UMTS, High Speed Downlink Packet Access (HSDPA) UMTS, Freedom of Mobile Multimedia Access (FOMA), Time Division-Synchronous Code Division Multiple Access (TD-SCDMA), Time Division-Code Division Multiple Access (TD-CDMA), UMTS-Time division duplexing (UMTS-TDD), UMTS Long Term Evolution (LTE), Frequency division multiplexing (FDM), Frequency division duplexing (FDD), Direct Sequence Ultra wide band (DS-UWB), Internet Protocol multimedia Subsystem (IMS), Session Initiation Protocol (SIP), Orthogonal Frequency Division Multiple (OFDM), Orthogonal Frequency Division Multiple Access (OFDMA), Software-defined radio (SDR), Personal Communications Service (PCS), High-Speed Circuit-Switched Data (HSCSD), Ultra Wideband (UWB), Wideband Integrated Dispatch Enhanced Network (WiDEN), Unlicensed Mobile Access (UMA), WiMax IEEE 802.16, WiFi IEEE 802.11, Wireless Local Area Network (WLAN), Circuit Switched Data (CSD), wireless wide-area network (WWAN), Voice over Internet Protocol (VoIP), time division multiple access (TDMA), Wireless Broadband (WiBro), Time Division CDMA (TD-CDMA), Voice over WLAN (VoWLAN), Multiple-input multiple-output (MIMO), Variable-Spreading-factor Spread Orthogonal Frequency Division Multiplexing, Push to Talk (PTT), Signaling System 7 (SS7), SS7 over IP, Message Transfer Part-Level 2 Peer-to-Peer Adaptation Layer (M2PA), Message Transfer Part-Level 3 User Adaptation Layer (M3UA), Common Channel Signaling System 7 (CCS7), Transmission Control Protocol/Internet Protocol (TCP/IP), Hyper Text Transfer Protocol (HTTP), Hyper Text Transfer Protocol Secure (HTTPS), User Datagram Protocol (UDP).

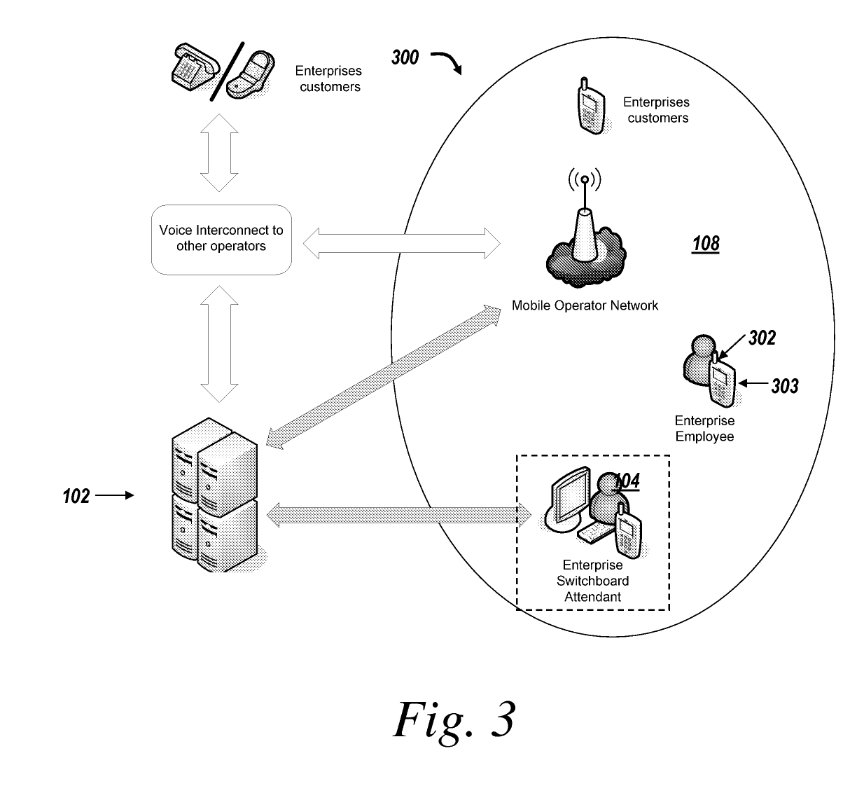

With reference to FIG. 3, an exemplary embodiment of a system 300 for providing telephony services by a service provided independent of a telephone network operator is shown and described. The system includes a data center 102, a mobile telephone network 108, and an enterprise having one or more employees 302 having an associated mobile device 303 and an enterprise operator 104 having a computing device 105 executing software that communicates with the data center 102.

The mobile network 108 communicates with the data center 102. The mobile network 108 receives signaling from the data center 102 and sends signaling to the data center 102. Also, the both the data center 102 and the mobile network 108 provides signaling to the mobile device 303 of the employee 302 of the enterprise. In one embodiment, the signaling includes SS7 signaling. In other embodiments, the signaling includes, but is not limited to, OSA/Paraly, Paraly X, SIP, PacketCable, SS7oIP, and other signaling methods. Also, various combinations of signaling protocols can be used.

The enterprise operator 104, via the associated computing device 105, communicates with the data center 102. The computing device 105 sends commands to and receives data from the data center 102. The commands and data include, but are not limited to, instructions to transfer an incoming call to enterprise employee, place a call on hold, data related to the call status (e.g., elapsed time, caller id, call control commands, messaging commands, configuration commands, status about calls, handset status, queues, conferences, and others

The data center 102 terminates a fixed line main number of the enterprise subscribing for PBX services. In one embodiment, the fixed line main number is a toll free number. In other embodiments, the fixed line main number is a local number.

As an operational overview, a customer calls the enterprises main number. It is a fixed line number and customer only incurs a fixed line charge (which could be zero depending on their operators price plans). The customer is connected to the data center 102 where an IVR system welcomes the customer and for calls directed to the enterprise operator 104 places the customers call on hold playing music.

Next, the data center 102 locates an available enterprise operator 104 and initiates a call setup between the phone of the enterprise operator 104 and the data center 102 center. In response, the mobile network 108 sets up a call leg to the enterprise operator 104. As a result, the enterprise operator 104, and therefore the enterprise, incur a fixed line charge. Once the enterprise operator 104 answers the incoming call, the enterprise operator 104 audio stream is connected to the waiting customer's audio stream and the enterprise operator 104 begins servicing the waiting customer.

The data center 102, also sends information about the call (e.g., caller ID) to a display screen of the enterprise operator 104. If the enterprise operator 104 chooses to transfer the customer call to an employee 302 of the enterprise, the transfer is accomplished within the mobile network 308. If the employee 302 is using a mobile phone 303 within the same network of the enterprise's price plan there is typically no extra charge for transferring the call.

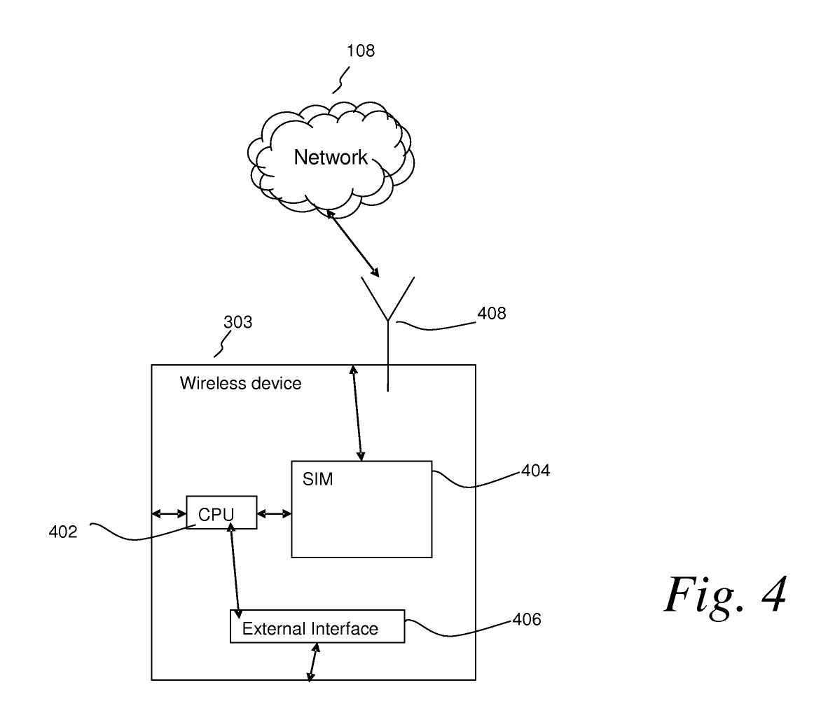

Referring now to FIG. 4 a block diagram depicting one embodiment of a mobile device 303, which is also referred to as a wireless device throughout the specification, that is connected to a mobile network 108 is shown. In brief overview, a wireless device 303 comprises a Central Processing Unit (CPU) 402, an optional Subscriber Identity Module (SIM) 404, a radio transceiver 408 and an external interface (EI) 406. The wireless device 303 may be in communication with one or more networks (e.g., mobile network 108 and IP network 110) and may be in communication with one or more transmitter/receiver stations 113 of FIG. 2.

Still referring to FIG. 4, now in greater detail, a wireless device 303 is shown. As used herein, the term wireless device refers to any device capable of transmitting and receiving voice and/or data (non-voice) information to and from a network without the use of wires, cables or other tangible transmission media. In one embodiment, the wireless device 303 may comprise a mobile phone. In other embodiments, a wireless device may comprise a cellular phone, a smart phone, a fixed-mobile convergence phone, a satellite phone, a wireless data card, a wireless personal digital assistant (PDA), a wireless modem or computers and electronic systems that communicate wirelessly.

In the embodiment shown, the wireless device 303 comprises an optional SIM 404. A SIM 404 may be a smart card that may comprise one or more of: CPU, Cryptographic Processor, Read only memory (ROM), Random access memory (RAM), Electrically-Erasable Programmable Read-Only Memory (EEPROM) and input/output circuits.

A SIM 404 may be used to store unique subscription and authentication information about the owner of the SIM 404, the network that the SIM 404 has permission to connect to, the services that the SIM 404 may access on a network and an address book of telephone numbers. A SIM 404 may comprise one or more valued added applications. Such applications may comprise: banking, biometric, medical, security, productivity, identity management, digital signature, public key infrastructure (PKI), multimedia, ticketing, digital rights management, gaming, and loyalty applications. The SIM applications may employ SIM Application Toolkit (SAT) technology or other smart card application technologies.

In another embodiment a wireless device may comprise a Universal Integrated Circuit Card (UICC) in place of a SIM. A UICC may comprise one or more Identity Module (IM) technologies of: GSM Subscriber Identity Module (SIM), UMTS Internet Protocol Multimedia Services Identity Module (ISIM), CDMA Removable User Identity Module (R-UIM), plus value added applications. The UICC applications may use one or more technologies of: USAT (Universal SIM Application Toolkit), CCAT (CDMA Card Application Toolkit), CAT (Card Application Toolkit), UATK (UIM Application Toolkit) or other smart card technologies. In this context SIM 404 is used generically to represent both the SIM card and the UICC with a USIM, or other IM, application residing on the UICC.

In the embodiment shown, a wireless device 303 may include an external interface (EI) 406. An external interface may comprise one or more of: man-machine interface (MMI) and machine to machine interface (M2M). An MMI may comprise any device allowing a person to interact with or operate the wireless device, including without limitation a computer application, a screen, camera, finger print reader, a keyboard, a keypad, a microphone, optical sensor, audio sensor, a motion sensor, a speaker. An M2M may comprise any device allowing another device to exchange data with the wireless device or operate the wireless device, including without limitation, an RS-232 serial communication data port, manufacturer's proprietary communication data port, Universal Serial Bus (USB) data port, Bluetooth transceiver data port, Ultra Wideband (UWB) transceiver data port, Infrared data port, other short range radio frequency technology data port, or other data port that allows a wireless device to communicate with another device.

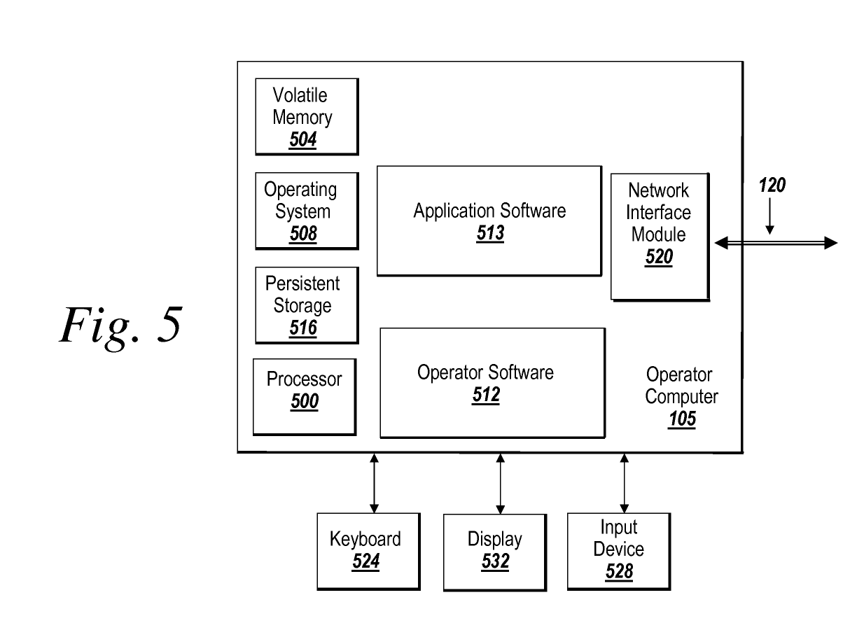

With reference to FIG. 5, an embodiment of a computing device 105 used by the enterprise operator 104 is shown and described. The computing device 105 can be any personal computer, Windows-based terminal, Network Computer, wireless device, information appliance, RISC Power PC, X-device, workstation, minicomputer, main frame computer, cellular telephone smartphone, personal digital assistant, or other computing device that provides sufficient faculties to execute applications and, in some embodiments operator software, and an operating system.

In further detail, the computing device 105 typically includes a processor 500, volatile memory 504, an operating system 508, operator software 512, application software 513 (e.g., a web browser, word processor, presentation software, and others), a persistent storage memory 516 (e.g., hard drive or external hard drive), a network interface 520 (e.g., a network interface card), a keyboard 524 or virtualized keyboard in the case of a PDA, at least one input device 528 (e.g., a mouse, trackball, space ball, light pen and tablet, touch screen, stylus, and any other input device), and a display 532. The operating system 508 can include, without limitation, WINDOWS 3.x, WINDOWS 95, WINDOWS 98, WINDOWS NT 3.51, WINDOWS NT 4.0, WINDOWS 2000, WINDOWS XP, WINDOWS VISTA, WINDOWS CE, MAC/OS, Java, PALM OS, SYMBIAN OS, LINSPIRE, LINUX, SMARTPHONE OS, and the various forms of UNIX.

In one embodiment, the operator software 512 is in communication with various components of the computing device 105 and provides features and functions described in more detail below. In other embodiments, the computing device executes a web browser application 513. The computing device accesses web pages provided by a component of the data center 102. Various telephony services are accessed via the web pages.

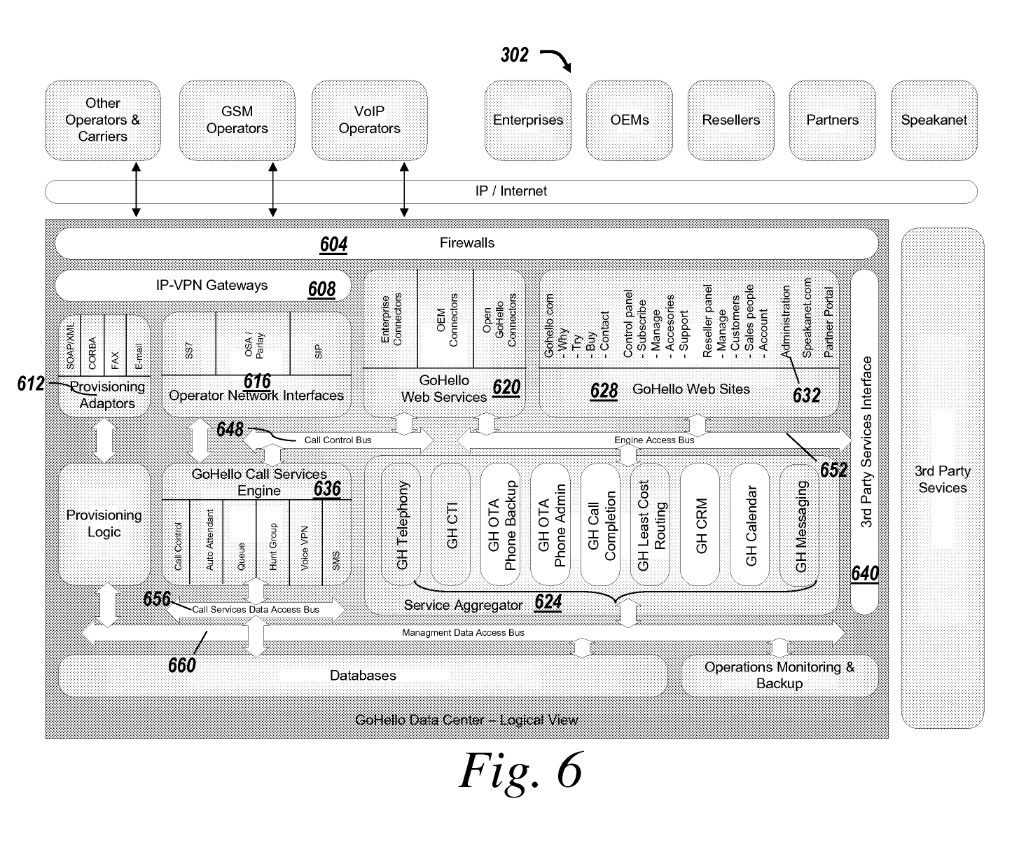

With reference to FIG. 6, a conceptual block diagram of an embodiment of a data center 102 is shown and described. Various components of the data center (e.g., the web server 116, the control device 118, and the NOC 120) can be embodied as hardware, software, middleware, or any combination thereof. In some embodiments, some of the components execute on a computing device similar to that computing device 105 of the enterprise operator 104. In other embodiments, some of the components execute on one or more server computing devices having similar components to those of the computing device 105.

The data center 102 includes one or more firewalls 604, a IP-VPN gateway 608, provisioning adapters 612, a operator network interfaces 616, web services interface 620, one ore more web sites 628, an administrative site 632, a call services engine 636, a third party web service interface 640, and service aggregator 624. The data center 102 also includes a number of buses to provide communications among the various components. More specifically, the call center 102 includes a call control bus 648, an engine access bus 652, a call service data access bus 656, and a management data access bus 660. Various combinations of all, some, and additional components that are not shown can also be included in other embodiments of the data center 102.

In one embodiment, the firewall 604 is a packet filter. In another embodiment, the firewall 604 is an application gateway. In other embodiments, the firewall is a circuit-level gateway or a proxy server. In general, the firewall prevents unauthorized access to or from the data center 102. The firewall 104 can be implemented in both hardware and software, or a combination of both. In one embodiment the firewall 104 is a PIX firewall manufactured by Cisco Systems, Inc. of San Jose, Calif.

In one embodiment, the IP-VPN gateway 608 provides security and firewall traversal to deliver, in some cases, voice-traffic over an IP network. In another embodiment, the IP-VPN gateway 608 is a VoIP-VPN gateway that converts the analog voice signal to digital form, encapsulates the digitized voice within IP packets, then encrypts the digitized voice using IPSec, and finally routes the encrypted voice packets securely through a VPN tunnel. In one embodiment the IP-VPN gateway 608 is a VPN manufactured by Cisco Systems, Inc. of San Jose, Calif.

The provisioning adapters 612 can include any combination of a SOAP/XML adapter, a CORBA adapter, a fax adapter, an e-mail adapter, and any other adapter. The provisioning adapters 612 are configured using standard techniques and provide functionality to exchange messages with other components of the data center 102 and components of other networks.

The operator network interfaces 616 can include functionality to provide call signaling for a variety of protocols. For example, the operator network interfaces 616 can perform SS7 signaling, OSA/Parlay signaling, SIP signaling, as well as other types of signaling. In one embodiment, the operator network interfaces 616 can transmit signals into a mobile network 108 signals that trigger a mobile device 303 to initiate a call to data center 102.

In one embodiment, the web services interface 620 provides a means for partners of the telephony service provider that want to have access to all or some of the services and features described herein from their own web service or front-end application.

The data center 102 can also include one ore more web sites 628. The web sites can include information directed to subscription enrollment, payment processing, management features, accessories shopping, technical support, a partner portal, a reseller portal, and other information. The websites 628 are accessed using a web browser executing on a computing device.

In one embodiment, the administrative site 632 is also a web site that is accessed using a web browser executing on a computing device. The administrative site 632 provides a means by which administrative tasks can be performed on the data center 102. For example, the log files and other items can be retrieved from the data center 102 for analysis. Also, the administrative site 632 can provide a means to manage partner accounts and reseller accounts. Also, general accounting can be accomplished using the administrative site 632.

In one embodiment, the call service engine 636 provides at least some of the telephony services to the enterprise. For example, the call service engine 636 allows a number of attached mobile telephones to make calls to one another, and to connect to other telephone services including the PSTN. The call services engine 636 can provide, but is not limited to, call control functionality, auto attendant functionality, queuing functionality, hunting group functionality, voice VPN functionality, and short message service (SMS) functionality. Other functionality provided by the call services engine 636 can include, automatic call distributor, automated directory services (i.e., allowing calls to be routed to a given employee by keying or speaking the letters of the employee's name), automatic ring back, call accounting, call forwarding on absence, call forwarding on busy, call park, call pick-up, call transfer, call waiting, camp-on, conference call, custom greetings, customized abbreviated dialing (i.e., speed dialing), direct inward dialing, direct inward system access (DISA) (i.e., the ability to access internal features from an outside telephone line), follow-me, music on hold, night service, shared message boxes (i.e., allowing a department of an enterprise to share voicemail box), voice mail, and voice paging. In one embodiment, the call service engine 616 can be the open source ASTERISK PBX software or a commercially available IP PBX platform. In other embodiments, the call service engine 616 is a custom software application.

The third party web service interface 640 provides a means to interface with other third party web service providers. For example, data from the data center 102 can be sent to additional web sites via the interface. For example, usage information can be provided to a third party and a bill can be generated and sent to the enterprise based on usage by the enterprise. In other embodiments, the third party web service interface 640 can be used to extend the functionality of the data center 102. For example, a third party can provide fax services to the data center 102, which appear to be provided by the data center 102. Said another way, a third party partner can “power” additional functionality.

In one embodiment, the service aggregator 624 provides functionality related to, but not limited to, license key generation, service configuration, role based authentication, and account management. Additional functionality provided by the service aggregator 624 includes additional telephony services, CTI services, OTA phone backup services, OTA phone administrative services, call completion services, least cost routing services, CRM services, calendaring services, and messaging services. In general, the service aggregator 624 can package third party or party services within the data center 102 to extend the functionality of the data center 102.

The following example illustrates some features and functionality previously described. Initially, an enterprise customer issues a request (i.e., subscribes) for telephony services via a web site. As part of the subscription process, enterprise agrees to pay a fee for the service on a periodic basis. This can be a monthly, yearly, or weekly service charge. Other subscription periods can also be used.

The subscription process also includes associating, by the enterprise customer, one or more mobile telephone numbers or other telephone numbers with their subscription for telephony services. That is, in some embodiments, each mobile phone is assigned an “extension” of the enterprise. In another embodiment, the enterprise customer can request that mobile phone numbers (and their associated subscriptions) be obtained on their behalf. These phone numbers can be pre-paid type mobile phone subscriptions or other mobile phone subscription models can be used. The mobile phones are then forward to the enterprise subscribing for telephony services.

In addition, a central number (e.g., a fixed line main number) is also associated with the enterprise as part of the subscription process. This number can be ported from an existing network and terminated at the data center 102.

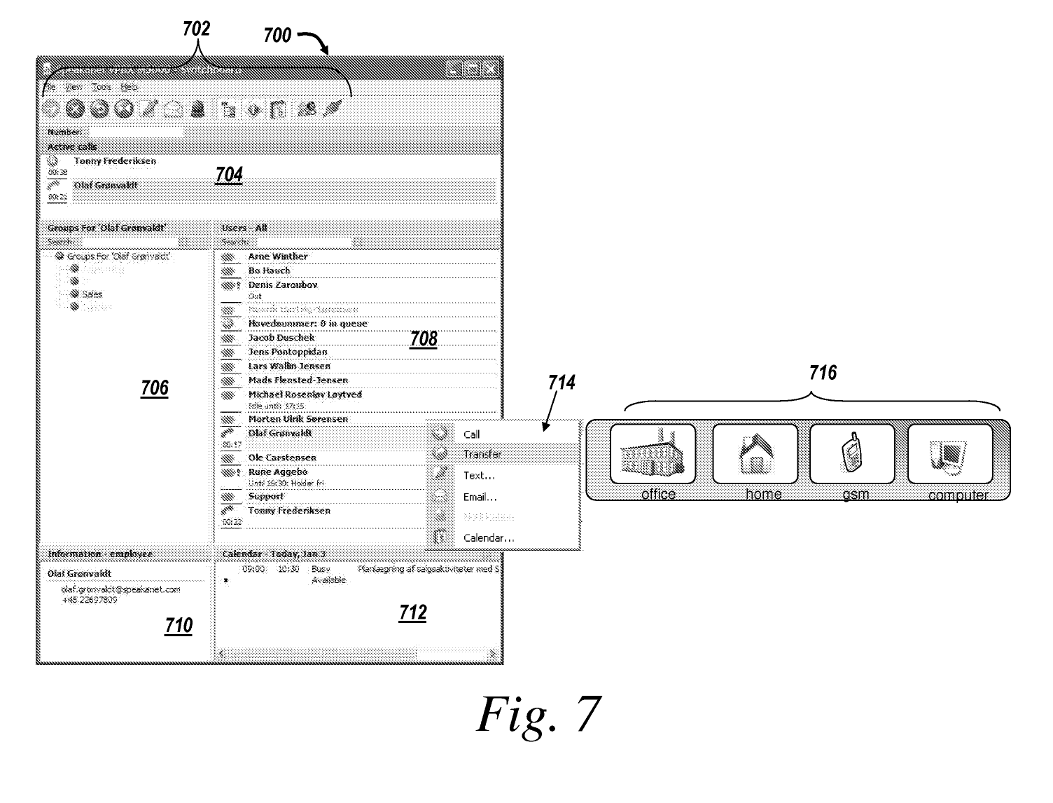

After completing the subscription process, the enterprise operator 104 can access the data center and download operator software 512 and install the operator software 512 on a computing device 105. In other embodiments, operator software is not executed locally. Instead, the enterprise operator 104 access the operator software 512 via a web browser. With reference to FIG. 7, the operator software 512 displays a graphic user interface (GUI) 700 to the enterprise operator 104. The GUI 700 provides a means for the operate to interact with the data center 102 to control calls to the enterprise and route them accordingly.

In one embodiment, the GUI 700 includes a plurality of action buttons 702, an active call display region 704, a group display region 706, a user display region 708, an information display region 710, and a calendar display region 712. In other embodiments, additional or fewer regions are provided as part of the GUI 700.

The action buttons 702 provide functionality related to the subscribed for telephony services. For example, one button that when activated by the enterprise operator causes the transfer of a call from one employee to another employee or another number or extension associated with the employee. Another button provides call ending functionality. Other functions provided by the action buttons can include, but are limited to: showing and hiding any of the an active call display region 704, a group display region 706, a user display region 708, an information display region 710, and a calendar display region 712; transmitting an e-mail or SMS message to an enterprise employee; calling an employee; and notifying an employee.

The active call region 704 displays a list of active calls being managed by the enterprise operator 104. In addition, the active call region 704 allows the enterprise operator to select an active call and perform one or more of the subscribed for telephone services thereon. Additionally, if the enterprise operator 104 selects an active call or listed user and activates a portion of the input device (e.g., clicks the right mouse button) a menu 714 is displayed to the enterprise operator 104. The menu lists one or more actions available to the enterprise operator 104. Selection of the one of the menu options results in the execution of the action. For example, a selecting an active call and highlight the transfer function of the menu 714 can result in the display of a number of icons 716 that represent destinations that the active call can be transferred to by the enterprise operator 104.

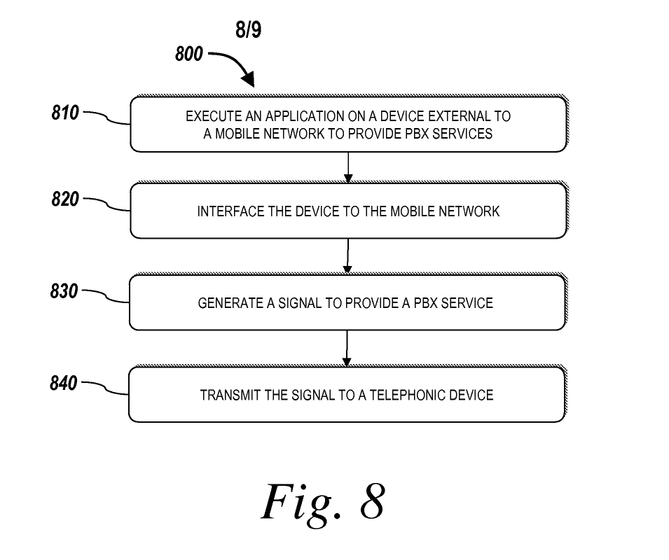

With reference to FIG. 8 a method of providing telephony services is shown and described. In one embodiment, the method includes executing (step 810) an application on a device external to a mobile network to provide PBX services, interfacing (step 820) the device to a mobile network, generating (step 830) a signal to provide a PBX service, and transmitting (step 840) the signal to a telephonic device.

In one embodiment, the application executes at the data center 102. The data center is not under control of the mobile network 108 operator. Instead, the data center 102 is owned and operated by a third party. The application can provide PBX services to an enterprise of mobile telephone subscribers. The customers of the enterprise are able to call a fixed line main number and maintain the cost benefits thereof.

The data center 102 interfaces (step 820) to a mobile network 108. In other embodiment, the data center also interfaces to an IP network and a fixed line network.

The data center 102 generates (step 830) a signal to provide at least a portion of the PBX service on the mobile network 108. For example, the data center generates 102 a signal to establish a call between the data center and a mobile telephone 303. The call can be established using different techniques. In one embodiment, the data center directly establishes the call in the mobile operators network using standard like OSA/Parlay, Parlay X, SS7 or SIP. In another embodiment, a switchboard software application executing on the enterprise operators computing device 105 communicates directly via a local data connection (e.g., cable, Bluetooth, or wireless) to a mobile phone of the enterprise operator and thereby initiates the call. In another embodiment, an application executing directly on the mobile device 303 is signaled to initiate the call. Also, manually initiating the call can be used (e.g., keying in or speed dial the number to call). Also, a dedicated terminal with one of the mobile operators SIM cards can be used. In such an embodiment, the terminal gets is signaled from the data center 102, sets up two call legs, one to the data center 102 and one to the enterprise operator 104. The terminal then connects the two call legs and leaves the call.

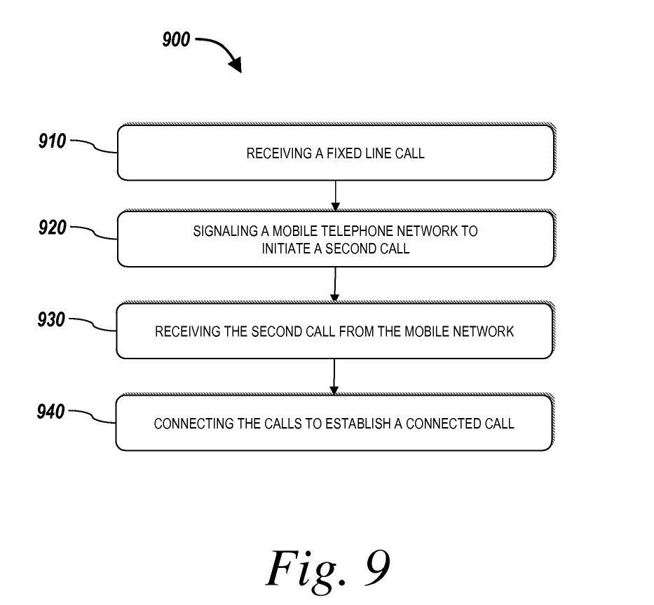

With reference to FIG. 9, a method of routing a call received at a fixed line number to an enterprise extension is shown and described. The method 900 includes receiving (step 910) an incoming telephone call via a fixed line number, signaling (step 920) a mobile telephone network to initiate a call, receiving (step 930) a second incoming call from the mobile telephone network, and connecting (step 940) the calls to establish a connected call.

In one embodiment, the fixed line main number is terminated at the data center 102, which is external to the mobile network 108. The data center receives (step 910) a customer call at that fixed line main number.

The data center 102 signals (step 920) the mobile telephone of the enterprise operator 104 and also issues call information to the computing device associated with the enterprise operator. In one embodiment, the signaling is issued to the mobile operator. In another embodiment, the signaling is issued directly to the mobile phone.

In response, the mobile phone initiates a call to the data center 102, which receives (step 930) the call. In one embodiment, the call is received via a second fixed line number. In another embodiment, the call is received via mobile number. In yet another embodiment, the call is received via the same fixed line number. Also, the call can be received by a phone number associated with an IP network.

Once received, the data center 102 connects (step 940) the two calls to create a connected call. In one embodiment, the calls are connected on the mobile network 108. In another embodiment, the calls are connected on a fixed line network 122. Also, the calls can be connected on an IP network 110. In some embodiments, the calls are connected in the data center 102.

The previously described embodiments may be implemented as a method, apparatus or article of manufacture using programming and/or engineering techniques to produce software, firmware, hardware, or any combination thereof. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.), a file server providing access to the programs via a network transmission line, wireless transmission media, signals propagating through space, radio waves, infrared signals, etc. The article of manufacture includes hardware logic as well as software or programmable code embedded in a computer readable medium that is executed by a processor. Accordingly, the spirit and scope of the above-described features is to be limited only by the following claims.

What is claimed is:

1. A method of routing a call received at a fixed line number to an enterprise extension, the method comprising:
(a) receiving, at a site external to a mobile telephone network, an incoming telephone call via a first fixed line telephone number;
(b) signaling a mobile telephone network to initiate a call to the site external to the mobile telephone network;
(c) receiving a second incoming call from a mobile telephone of the mobile telephone network via a second fixed line telephone number; and
(d) connecting the first incoming telephone call to the second incoming telephone call to establish a connected call.

2. The method of claim 1 wherein the first fixed line number and the second fixed line number are the same.

3. The method of claim 1 further comprising issuing a transfer command to the mobile telephone network to transfer the connected call to another mobile telephone.

4. The method of claim 1 further comprising issuing a transfer command to the mobile telephone to transfer the connected call to another mobile telephone.

5. The method of claim 1 wherein signaling a mobile telephone network comprises signaling a mobile telephone network to initiate a call to the mobile telephone and the site external to the mobile network.

6. The method of claim 1 further comprising signaling an intermediate component of the mobile telephone network to initiate a call to the mobile phone and the site external to the mobile network to establish the connected call.

7. The method of 6 wherein signaling an intermediate component of the mobile telephone network comprises signaling a second mobile telephone of the mobile telephone network.

8. A system for routing a call received at a fixed line number to an enterprise extension, the system comprising:
(a) means for receiving, at a site external to a mobile telephone network, an incoming telephone call via a first fixed line telephone number;
(b) means for signaling a mobile telephone network to initiate a call to the site external to the mobile telephone network;
(c) means for receiving a second incoming call from a mobile telephone of the mobile telephone network via a second fixed line telephone number; and
(d) connecting the first incoming telephone call to the second incoming telephone call to establish a connected call.

9. The system of claim 8 wherein the first fixed line number and the second fixed line number are the same.

10. The system of claim 8 further comprising means for issuing a transfer command to the mobile telephone network to transfer the connected call to another mobile telephone.

11. The system of claim 8 further comprising means for issuing a transfer command to the mobile telephone to transfer the connected call to another mobile telephone.

12. The system of claim 8 wherein the means for signaling a mobile telephone network comprise means for signaling a mobile telephone network to initiate a call to the mobile telephone and the site external to the mobile network.

13. The system of claim 8 further comprising means for signaling an intermediate component of the mobile telephone network to initiate a call to the mobile phone and the site external to the mobile network to establish the connected call.

14. The system of claim 13 wherein the means for signaling an intermediate component of the mobile telephone network comprise means for signaling a second mobile telephone of the mobile telephone network

15. A computer readable medium having instruction thereon to of routing a call received at a fixed line number to an enterprise extension, the computer readable medium comprising:
(a) instructions to receive, at a site external to a mobile telephone network, an incoming telephone call via a first fixed line telephone number;
(b) instructions to signal a mobile telephone network to initiate a call to the site external to the mobile telephone network;
(c) instructions to receive a second incoming call from a mobile telephone of the mobile telephone network via a second fixed line telephone number; and
(d) instructions to connect the first incoming telephone call to the second incoming telephone call to establish a connected call

16. The computer readable medium of claim 15 further comprising instructions to issues a transfer command to the mobile telephone network to transfer the connected call to another mobile telephone.

17. The computer readable medium of claim 15 further comprising to issue a transfer command to the mobile telephone to transfer the connected call to another mobile telephone.

18. The computer readable medium of claim 15 wherein the instructions to signal a mobile telephone network comprises instructions to signal a mobile telephone network to initiate a call to the mobile telephone and the site external to the mobile network.

19. The computer readable medium of claim 15 further comprising instructions to signal an intermediate component of the mobile telephone network to initiate a call to the mobile phone and the site external to the mobile network to establish the connected call.

20. The computer readable medium of claim 19 wherein the instructions to signal an intermediate component of the mobile telephone network comprise instructions to signal a second mobile telephone of the mobile telephone network.
